(19) United States
(12) Patent Application Publication
(10) Pub. No.: US 2004/0084806 A1
(43) Pub. Date: May 6, 2004

(54) Method for using static liquid pressure to compact large fiber reinforced composite structures

(76) Inventors: Paul S Biermann, Columbia, MD (US); Walter Chappas, Raleigh, NC (US)

Correspondence Address: Benjamin Y Roca, The Johns Hopkins University, Applied Physics Laboratory, 11100 Johns Hopkins Road Mail Stop 7-156, Laurel, MD, 20723-6099, US

(21) Appl. No.: 10/466,919

(22) PCT Filed: Jan. 23, 2002
(86) PCT No.: PCT/US02/01982

(30) Foreign Application Priority Data
Jan. 23, 2001 (US) 60263549

(51) Int. Cl. B29C 35/08

(52) U.S. Cl. 264/319; 425/174.4

(57) ABSTRACT

A process of fabricating a molded body. A molding tool operable to mold the body is submersed under a body of liquid to a depth sufficient to exert a pressure greater than atmospheric pressure on at least one of the molding tool and resin forming the molded body.

### CROSS-REFERENCE TO RELATED APPLICATIONS

This application claims the benefit of prior filed co-pending U.S. Provisional Patent Application No. 60/263,550, filed on Jan. 23, 2001.

### BACKGROUND OF THE INVENTION

1. Field of the Invention

The present invention relates to an apparatus and a process for molding a resinous body. In particular, the present invention provides a method and apparatus for exerting pressure on the resinous body to improve the properties of the resinous body.

2. Description of Related Art

In forming a body from resinous material, the resin is often subjected to pressure, whether positive or negative, to help ensure transfer of the resin throughout the mold and also into any preform utilized to form the body. One process utilized for forming resinous bodies is vacuum assisted resin transfer molding (VARTM). VARTM includes application of a pressure below atmospheric pressure, typically substantially a vacuum, to encourage the flow of resin into a molding tool. The molding tool may include only one side that shapes the resin. A bag or other member may be utilized to contain the resin opposite the molding tool. The molding tool may also include two sides, with the resin being sandwiched between.

Resin is supplied to the molding tool through a resin in-line. The resin may be under pressure. The reduced pressure is applied to the resin through an out-line. The pressure differential applied to the resin assists its movement into the molding tool and possibly through any preform to be infused with resin. After infiltration of the resin into the mold and possibly preform, the vacuum typically must be reduced to help prevent boiling and void formation in the resin prior to crosslinking. The result is a trade-off between the available pressure that can be applied to the compact a resin infused laminate and the point at which bubbles form in the resin.

One way to overcome the shortcomings of known VARTM processes includes clamping a multi-part closed mold in a press. Pressure is then applied to the mold and, hence, to a composite laminate in the mold utilizing an autoclave or hydroclave to increase local ambient pressure. Such solutions are costly in terms of capital equipment and are impractical for very large components such as parts of or entire boat hulls, truck bodies, railcar bodies, windmill blades, and infrastructure components, among other articles.

### SUMMARY OF THE INVENTION

The present invention provides a process of fabricating a molded body. According to the process, a molding tool operable to mold the body is submersed under a body of liquid to a depth sufficient to exert a pressure greater than atmospheric pressure on at least one of the molding tool and resin forming the molded body.

Additionally, the present invention provides an assembly for fabricating a molded body. The assembly includes a molding tool operable to mold the body. A flexible enclosure maintains the body isolated from a body liquid in which the assembly is immersed. A resin in-line introduces resin into the molding tool. A vacuum out line applies a vacuum force to the molding tool to draw resin into the molding tool.

Still other objects and advantages of the present invention will become readily apparent by those skilled in the art from a review of the following detailed description. The detailed description show and describes preferred embodiments of the present invention, simply by way of illustration of the best mode contemplated of carrying out the invention. As will be realized, the present invention is capable of other and different embodiments and its several details are capable of modifications in various obvious respects, without departing from the invention. Accordingly, the drawings and description are illustrative in nature and not restrictive.

### BRIEF DESCRIPTION OF THE DRAWINGS

Objects and advantages of the present invention will be more clearly understood from the following specification when considered in conjunction with the accompanying drawings, in which:

FIG. 1 represents a cross-sectional view of an embodiment of an apparatus according to the present invention.

### DETAILED DESCRIPTION

The present invention provides a process and apparatus that employs liquid pressure to compact molded resin-containing structures. Along these lines, according to the present invention a molding tool is submersed in a body of liquid sufficient to exert a pressure greater than atmospheric pressure on the molding tool and/or the body being fabricated. By doing so, the present invention can apply a pressure to a body being molded that is in excess of a pressure differential between ambient pressure in a processing room and a negative pressure applied in VARTM processes. Through the increased pressure, the present invention can fabricate superior products.

The present invention is also particularly useful with a variation of VARTM that may be referred to as differential VARTM (DVARTM). DVARTM can since provide a method of increasing the pressure beyond the differential pressure created by the vacuum. DVARTM employs a combination of low pressure and vacuum to drive infiltration of the resin into the molding tool and preform. By minimizing the differential pressure between the resin inside and the water column outside, the tendency to form leaks can be reduced greatly.

The simplicity of the present invention also provides advantages. Along these lines, the present invention does not require a pressure vessel to apply the pressure, unlike known processes that utilize an autoclave or hydroclave. The maximum practical size of autoclaves limits the sizes of structure that can be produced under pressure. By eliminating the need for an autoclave, this Static Liquid Pressure (SLiP) process according to the present invention can permit the high-pressure curing of structures of any size.

Additionally, the present invention does not require equipment, such as pumping and/or pressurizing equipment, associated with such known processes. Along these lines, the present invention utilizes the compacting pressure of a mass of liquid to increase pressure on a laminate during curing. An advantage of the present invention is that any mass of liquid, such as any sufficiently large body of water could be utilized. By eliminating the need for a pressure vessel, the present invention is not limited to forming structures of a certain size and is particularly useful in fabricating large fiber reinforced composite structures. Examples of large fiber reinforced structures that the present invention could be utilized to form include boat hulls, truck and railcar bodies, windmill blades and infrastructure components.

The present invention permits the pressurization system to be greatly simplified in comparison to those required for traditional resin transfer molding since the pressures involved with the present invention will be much lower. The pressure forces the resin to flow into the tool, around and through any reinforcement materials. In a traditional system the tool typically needs to be very bulky to contain the pressure over the entire surface area of the part. Higher pressures are required with such traditional tools with more reinforcement filling the cavity.

Embodiments of the present invention can utilize any body of water, such as a tank, a swimming pool, a floating dry-dock in a shipyard to create a water column over a component being molded. Other embodiments could extend the concept of the present invention to a floating factory operating in deep water to achieve higher pressures, if required. Still other embodiments could be utilized to form tunnel sections in place at the bottom of a bay or harbor.

As is apparent from the above, water is the most readily available fluid with which to operate the present invention. However, any fluid could be utilized. One benefit of water is its ready availability and density. Along these lines, water is approximately 64 pounds of pressure per cubic foot, or about 0.037 pounds of pressure per cubic inch. Therefore, for each foot of water overlying a body being molded, the water provides about .0.444 pounds of pressure per square inch of the component. One atmosphere of pressure may be placed on a component being molded for each 33 feet of depth in water.

Typically, an article would be submerged to a depth of about 16 feet to about 120 feet. Alternatively, the pressure that an article would be subjected to would be about 7.1 psi to about 53 psi. Of course, an article may be submerged to any depth sufficient to apply a desired pressure.

According to the present invention, a molding tool is submersed in a body of liquid sufficient to exert a pressure greater than atmospheric pressure on the molding tool and/or the body being fabricated. In embodiments that include a multi-part mold, the liquid will exert pressure on the mold parts, which will transmit the pressure to the body being molded inside. Where the molding tool only includes one part, the liquid will exert pressure on an enclosure that retains resin and a preform on one side of the mold.

Although the present invention may be employed with many molding techniques, it is particularly useful and effective with vacuum assisted resin transfer molding processes. In VARTM, a fibrous reinforcing preform is introduced into a molding tool. The present invention may be utilized with any fibrous and/or fabric perform. If the molding tool includes multiple parts, the preform will be introduced between the parts. If the molding tool includes only one part, the preform will be introduced into a space between the molding part and an element for containing the preform and the resin. Similar to the perform, the present invention may be utilized with any type of resin, although certain resins, fibers and/or fabrics may be more suitable to use with the present invention. However, those of ordinary skill in the art would be able to determine suitable resins and/or perform materials without undue experimentation once aware of the disclosure contained herein.

The molding tool will include a resin in-line for introducing resin into the mold. The resin in-line will be connected to a source of resin. The resin source may be pressurized or the resin pumped through the resin in-line to help deliver the resin to the molding tool. In VARTM, a line is also connected to the molding tool to transmit a reduced pressure to the molding tool to transmit a reduced pressure to the molding tool to further assist the resin to enter the mold and infuse the preform. The line transmitting the reduced pressure is typically referred to as a vacuum line, even though the reduced pressure may not be a vacuum.

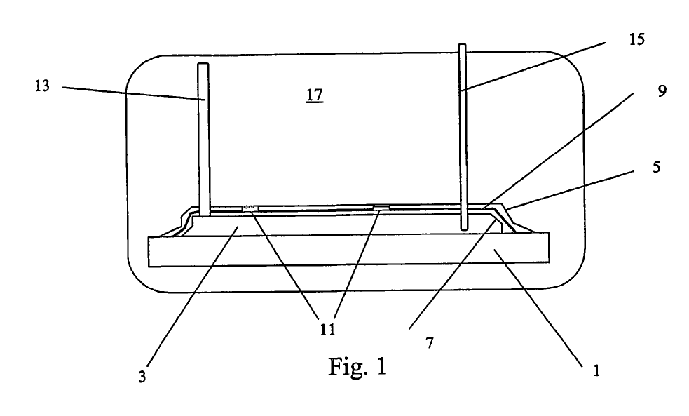

Regardless of whether the molding tool includes one or more than one part, the molding tool may be enclosed in an enclosure prior to being submersed in the body of liquid. The enclosure is meant to prevent the infiltration of the liquid into the molding tool and into contact with the resin. Such contact can have detrimental effects on the resin. The enclosure may surround the entire molding tool or just a portion of the molding tool. For example, the embodiment of the one piece molding tool shown in FIG. 1, the enclosure only covers the side of the molding tool where the preform will be located.

Typically, the enclosure that isolates the molded article from liquid infiltration is relatively flexible. This will help to maximize transmission of pressure to the article being molded. The flexibility of portions of the enclosure may be controlled to control application of pressure to various portions of the article being molded.

One reason for varying the pressure exerted on the body being molded is if portions of the body lie at different depths in the liquid. The portions lying at greater depths would experience greater pressure from the liquid. In the vicinity of these portions, the enclosure could be thicker. The enclosure could be thinner in the vicinity of regions of the body being molded that lie at lesser depths. In this manner, the pressure exerted on all portions of the body could be substantially equalized.

On the other hand, it may be desirable to exert pressure differentially on the body being molded. For example, it may be desired to have greater pressure exerted on thicker portions of the body being molded to facilitate transmission of the pressure to centrally located portions of the body. In this case, the enclosure may be thinner in where the body is thicker.

The difference in pressure from the top to the bottom of an article being molded may also be taken into account in locating a resin inlet port(s) and vacuum outlet port(s) as well as other features of the mold such as the timing of valves placed on the resin inlet ports and vacuum ports, the location of bleeder material to absorb and remove excess resin, and/or the location of critical process control sensors.

Another way to vary the pressure exerted on the article being molded is to take advantage of the variable pressure exerted by a liquid at different depths. If it is desired to exert more pressure on one portion of the article, that portion could be arranged at a greater depth than other portions. If it is desired to exert less pressure on portions of the article, then the article could be oriented in the liquid such that those portions are at a shallower depth and vice versa.

The enclosure may take many forms. According to one embodiment, the enclosure includes a flexible double layer polymer bag. The bag could be made of polyethylene or any other suitable polymer. Examples include silicone, butyl rubber, nitrile rubber, nylon, polyethylene terephthalate and/or PVC. The double layer will help to prevent penetration of liquid. Typically, each layer of such a double layer bag could have a thickness of about 0.001 inch to about 0.050 inch.

According to another embodiment, the enclosure includes a flexible caul. A caul typically comprises rubber inserts that achieve may be employed to vary the thickness of the enclosure. Along these lines, instead of making an enclosure described above that includes a complex outer vacuum bag of varying thickness, cauls may be employed to produce the effect by creating localized inserts that amplify or reduce pressure as desired. The use of cauls is particularly desirable for molding large objects, such as aircraft components, for example. Along these lines, a large enclosure is expensive to start with and utilizing cauls rather than producing a bag with varying thickness in different locations can reduce the extra cost.

The enclosure may include elements to help prevent and/or detect penetration of liquid through the enclosure. For example, the enclosure could include one or more sensors operable to detect penetration of liquid. Detection of penetration of liquid into the enclosure could trigger an alarm. The alarm could prompt operator response or an automatic response by a control system. If the sensor(s) detect liquid, the article being molded could be removed from the liquid prior to significant damage being done to the article. Alternatively, if penetration has occurred, the article could be inspected and possibly discarded if irreparable damage is detected.

In the embodiment of the invention that includes a double layer bag, the sensor(s) could be located between the layers of the bag. Infiltration of liquid between the outer and inner layers could permit the article to be removed before liquid penetrates the inner layer and damages the article. In other embodiments of the enclosure, the sensor(s) could be located elsewhere.

The resin may be transferred to the molding tool either before or after submersion of the molding tool. After the resin and molding tool have been subjected to pressure by submersion in the liquid, the resin may be subjected to curing energy. Subjecting the resin to curing energy may take place while the molding tool is submerged. Alternatively, the molding tool and resin may be subjected to curing energy after being removed from the liquid. This would typically only be employed if at least some curing takes place during the submersion. If the curing takes place with the molding tool and resin submerged, the resin may be partially or entirely cured while submerged.

The type of curing energy utilized will depend at least in part upon the nature of the resin and vice versa. Examples of types of curing energy can include ultraviolet radiation, e-beam radiation, infrared radiation, and high temperature, among others. Those of skill in the art would be able to determine the appropriate form(s) of curing energy to employ with the type of resin utilized and vice versa without undue experimentation once aware of the disclosure contained herein. If necessary or desired, catalysts or other functional compounds could be employed in the process.

If any curing fixtures required for the present invention typically would need to be resistant to any radiation employed during the curing. Also, the fixtures typically will need to be water resistant. Inexpensive materials and approaches typically will be possible for such fixtures. Along these lines, low-cost tooling and support materials may be an important advantage of the present invention as compared to known techniques.

Parameters necessary for curing may be determined to be suitable for the type of resin, curing energy, type of article involved, among other factors. Those of ordinary skill in the art will be able to determine proper curing parameters without undue experimentation once aware of this disclosure.

In addition to or as an alternative to the sensor(s), the enclosure may include one or more elements operable to seal any leak in the enclosure. This could make the enclosure self-sealing. In the embodiment of the invention that includes a double layer bag, a self-sealing sealant could be arranged between the two layers of the bag. In the event that liquid penetrates the outer layer of the bag, the liquid would come into contact with the sealant. The sealant would then physically or chemically react to seal the leak. Those of ordinary skill in the art would be able to determine a suitable self-sealing sealant to employ in this context without undue experimentation once aware of the disclosure contained herein.

One application where the present invention may find particular use is in shipbuilding technologies where FRP composites are utilized. Many composite structures must be cured under pressure to insure proper consolidation and, in the end, ultimate performance. Additionally, ship structures require all external surfaces to be hydrodynamically smooth. This places a limitation on tooling concepts that typically includes expensive matched die tools. For the largest naval structures, this can be very expensive, if not impossible. The present invention provides an innovative process for the manufacture of large-scale composite ship structure requiring high pressure and controlled surfaces during cure, without the need for an autoclave.

FIG. 1 illustrates an embodiment of a molding apparatus according to the present invention. The embodiment shown in FIG. 1 includes a one piece molding tool 1. A component 3 is being molded with the molding tool. A double bag including an outer bag 5 and an inner bag 7 isolates the isolates the resin from the liquid in which the molding tool is arranged. As described above sealant and/or at least one sensor typically is provided between the bag layers. For purposes of illustration, both a sealant 9 and sensors 11 are shown. However, an embodiment would typically only include one of a sealant and sensor(s). A resin in-line 13 feeds resin to the molding tool and a vacuum out-line 15 applies a reduced pressure to the molding tool. The entire assembly is arranged submerged in a body of liquid 17.

The foregoing description of the invention illustrates and describes the present invention. Additionally, the disclosure shows and describes only the preferred embodiments of the invention, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

We claim:

1. A process of fabricating a molded body, the process comprising:
submersing a molding tool operable to mold the body under a body of liquid to a depth sufficient to exert a pressure greater than atmospheric pressure on at least one of the molding tool and resin forming the molded body.

2. The process according to claim 1, wherein the molding tool is for vacuum assisted resin transfer molding.

3. The process according to claim 1, further comprising:
enclosing at least a portion of the molding tool in an enclosure operable to isolate the molded body from the liquid.

4. The process according to claim 3, wherein enclosing the molding tool in the enclosure comprises:
enclosing at least a portion of the molding tool in a flexible double layer bag.

5. The process according to claim 4, further comprising:
arranging moisture at least one sensor between an outer layer of the bag and an inner layer of the bag operable to detect water leaking through the outer layer of the bag.

6. The process according to claim 4, further comprising:
arranging a self-sealing sealant between an outer layer of the bag and an inner layer of the bag operable in the presence of water to seal leaks in the outer layer of the bag.

7. The process according to claim 3, wherein enclosing the molding tool in the enclosure comprises:
enclosing at least a portion of the molding tool in a flexible caul.

8. The process according to claim 1, further comprising:
transferring resin into contact with the molding tool.

9. The process according to claim 8, further comprising:
exposing the resin to curing energy.

10. The process according to claim 1, further comprising:
orienting the molding tool to control the depth of submersion and the pressure exerted parts of the molded body.

11. The process according to claim 1, wherein resin is transferred into contact with the molding tool prior to submersion of the molding tool.

12. An assembly for fabricating a molded body, the assembly comprising:
a molding tool operable to mold the body;
a flexible enclosure operable to maintain the body isolated from a body liquid in which the assembly is immersed;
a resin in-line operable to introduce resin into the molding tool; and
a vacuum out line operable to apply a vacuum force to the molding tool to draw resin into the molding tool.

13. The molding assembly according to claim 12, further comprising:
at least one source of curing energy operable to cure resin.

14. The molding assembly according to claim 12, wherein the source of curing energy comprises an e-beam radiation source.

15. The molding assembly according to claim 12, wherein the source of curing energy comprises an infrared radiation source.

16. The molding assembly according to claim 12, wherein the source of curing energy comprises an ultraviolet radiation source.

17. The molding assembly according to claim 12, wherein the enclosure comprises a double layer bag.

18. The molding assembly according to claim 17, wherein the enclosure further comprises:
at least one sensor arranged between an outer layer of the bag and an inner layer of the bag operable to detect water leaking through the outer layer of the bag.

19. The molding assembly according to claim 17, wherein the enclosure further comprises:
a self-sealing sealant arranged between an outer layer of the bag and an inner layer of the bag operable in the presence of water to seal leaks in the outer layer of the bag.

20. The molding assembly according to claim 12, wherein the enclosure comprises a caul.
